(19) United States
(12) Patent Application Publication
(10) Pub. No.: US 2016/0345385 A1
(43) Pub. Date: Nov. 24, 2016

(54) VAPORIZER HAVING A SURFACE FOR IMPROVED CONTACT POINT VAPORIZATION AND METHOD THEREOF

(71) Applicant: SMART SMOKES LLC, Albany, NY (US)

(72) Inventors: BRIAN SCHROEDER, ALBANY, NY (US); NICHOLAS PETRUCCO, ALBANY, NY (US); CHARLES HATHAWAY, TROY, NY (US)

(21) Appl. No.: 15/159,525

(22) Filed: May 19, 2016

Related U.S. Application Data
(60) Provisional application No. 62/163,604, filed on May 19, 2015.
(60) Provisional application No. 62/256,938, filed on Nov. 18, 2015.

(51) Int. Cl. H05B 3/14; H05B 3/00

(52) U.S. Cl. CPC H05B 3/148; H05B 3/0014

(57) ABSTRACT

An apparatus including a medium collection device having a vaporization contact surface, the medium collection device configured to attach to a nail base wherein the medium collection device is comprised at least partially of silicon carbide (SiC), optical or semi conducting quartz, or synthetic sapphire, is provided. Also provided is a vaporizer including a nail base, and a vaporization component operably connected to the nail base, the vaporization component including a medium collection device and a coupler, wherein the coupler secures the medium collection device to the nail base by threaded engagement between the coupler and the nail base. An associated method is further provided.

### CROSS-REFERENCE TO RELATED APPLICATIONS

This application claims the benefit of and priority to U.S. Provisional Application No. 62/163,604, filed May 19, 2015, and U.S. Provisional Application No. 62/256,938, filed Nov. 18, 2015.

### FIELD OF TECHNOLOGY

The following relates to a vaporizer and more specifically to embodiments of a vaporizer having an improved contact surface for vaporization of essential oils, herbs, and extracts.

### BACKGROUND

Vaporizers are used for the purpose of vaporizing essential oils, herbs, or extracts. The vaporizers include a surface upon which the essential oils, herbs, or extracts are heated on until vaporization occurs. A number of factors are considered when selecting the material that comprises the surface for vaporizing the oils, including thermal and chemical properties, such as efficient heat transfer and the ability to withstand surface adhesion of the oils for easy maintenance and surface cleanup, and machinability for assembly and manufacture.

Silicon carbide (SiC) is a compound widely used in the field of semiconductor electronic applications, particularly, in high temperature environments. Silicon carbide has a high thermal conductivity and chemical resistance. However, silicon carbide exhibits poor machinability as it relates to the manufacture and assembly. Materials such as natural sapphire, synthetic sapphire, optical quartz, and semi conducting quartz also exhibit poor machinability. For instance, standard or conventional design concepts like screw threading cannot be used, and a designer would need to accommodate its low fracture toughness and other undesirable material properties.

Accordingly, silicon carbide is not used as a material in the construction of vaporizers. The materials used in the vaporization industry sacrifice one or more of thermal and chemical properties in exchange for a material that can be more easily manufactured and assembled.

Thus, a need exists for an apparatus and method for a vaporization surface that possesses desirable thermal and chemical properties but can also be efficiently machined for assembly and/or manufacture.

### SUMMARY

A first aspect relates generally to an apparatus comprising: a medium collection device having a vaporization contact surface, the medium collection device configured to attach to a nail base, wherein the medium collection device is comprised at least partially of silicon carbide (SiC), optical or semi conducting quartz, or synthetic sapphire.

A second aspect relates generally to a vaporizer comprising: a nail base, and a vaporization component operably connected to the nail base, the vaporization component including a medium collection device and a coupler, wherein the coupler secures the medium collection device to the nail base by threaded engagement between the coupler and the nail base

A third aspect relates generally to a method comprising: forming a medium collection device at least partially of silicon carbide, optical or semi conducting quartz, or synthetic sapphire to improve a vaporization contact surface, and operably coupling the medium collection device to a nail base by using a coupler, so that the medium collection device may not require threads, but also be securably attached to the nail base.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts an exploded assembly view of an embodiment of a vaporizer;

FIG. 1B depicts a front view of an embodiment of the vaporizer;

FIG. 1C depicts a cross-sectional view along line A-A of FIG. 1B of an embodiment of the vaporizer;

FIG. 1D depicts a cross-sectional view along line A-A of FIG. 1B of an embodiment of the vaporizer having medium placed within an embodiment of a medium collection device;

FIG. 2 depicts an assembled view of an embodiment of the vaporizer;

FIG. 3 depicts a perspective view of an embodiment of the medium collection device;

FIG. 4 depicts a perspective view of an embodiment of a vaporization component having a medium collection device and an embodiment of a retainer coupler;

FIG. 5 depicts a perspective view of an embodiment of the vaporization component having a medium collection device and an alternative embodiment of the retainer coupler;

FIG. 6 depicts an exploded, assembly view of an embodiment of a vaporizer without a heating element; and

FIG. 7 depicts a cross-section view of an embodiment of a vaporizer without a heating element.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

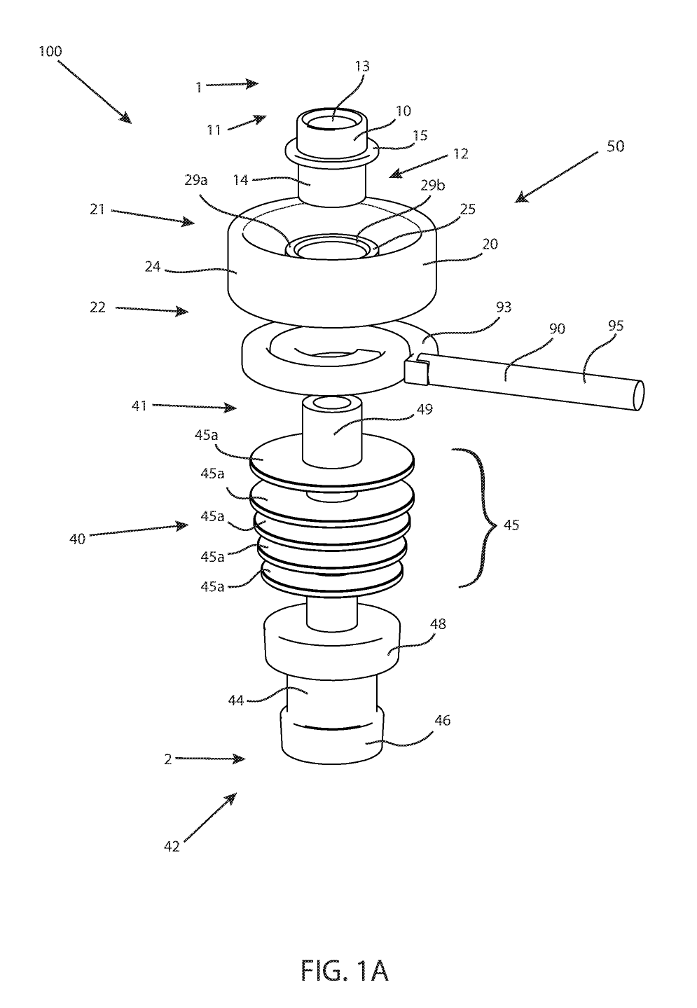

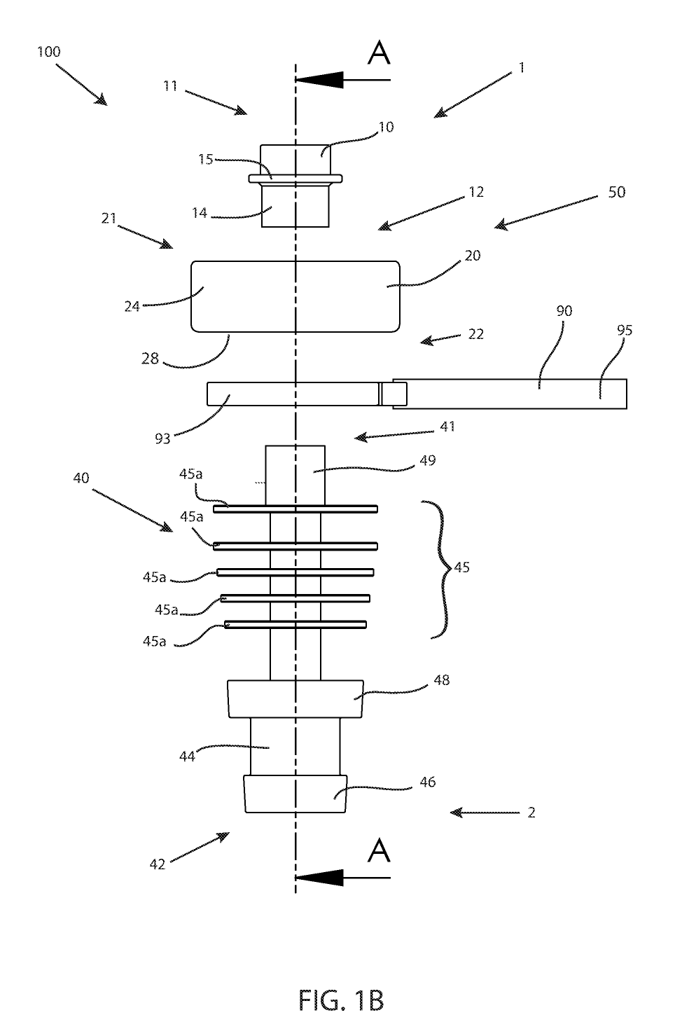

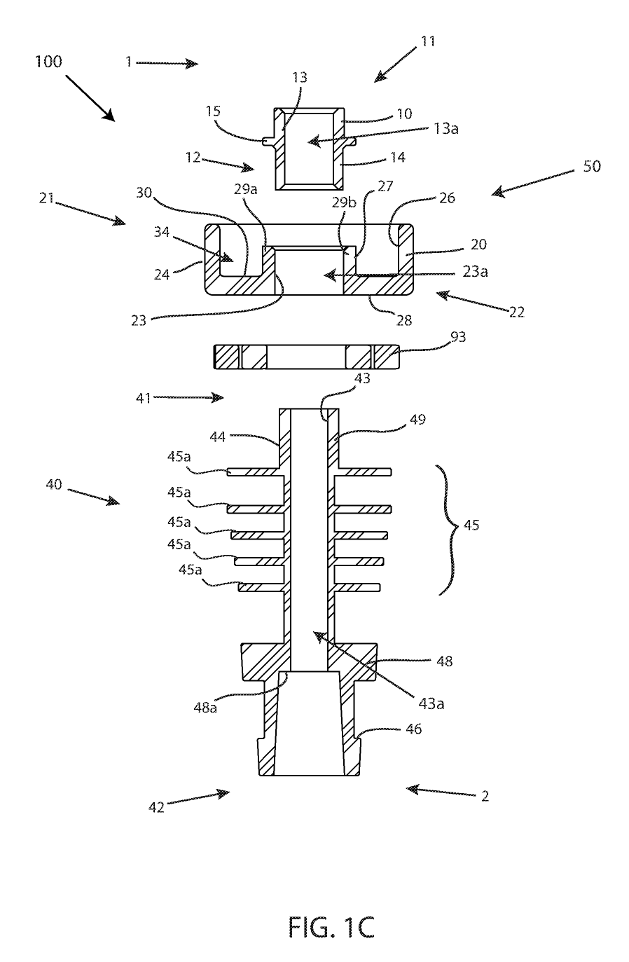

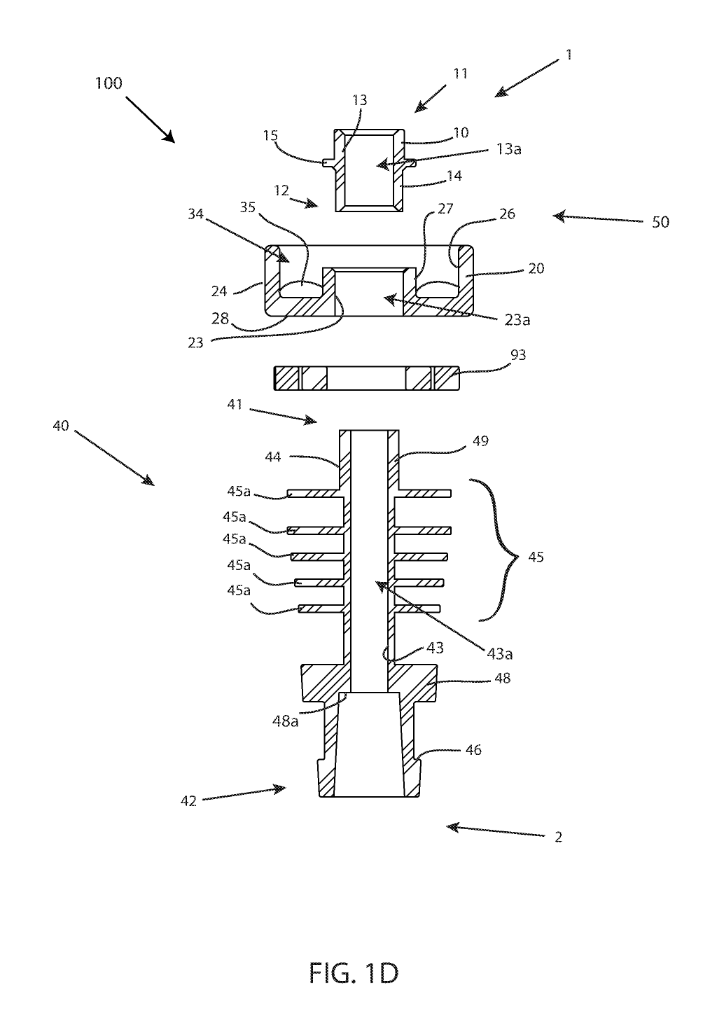

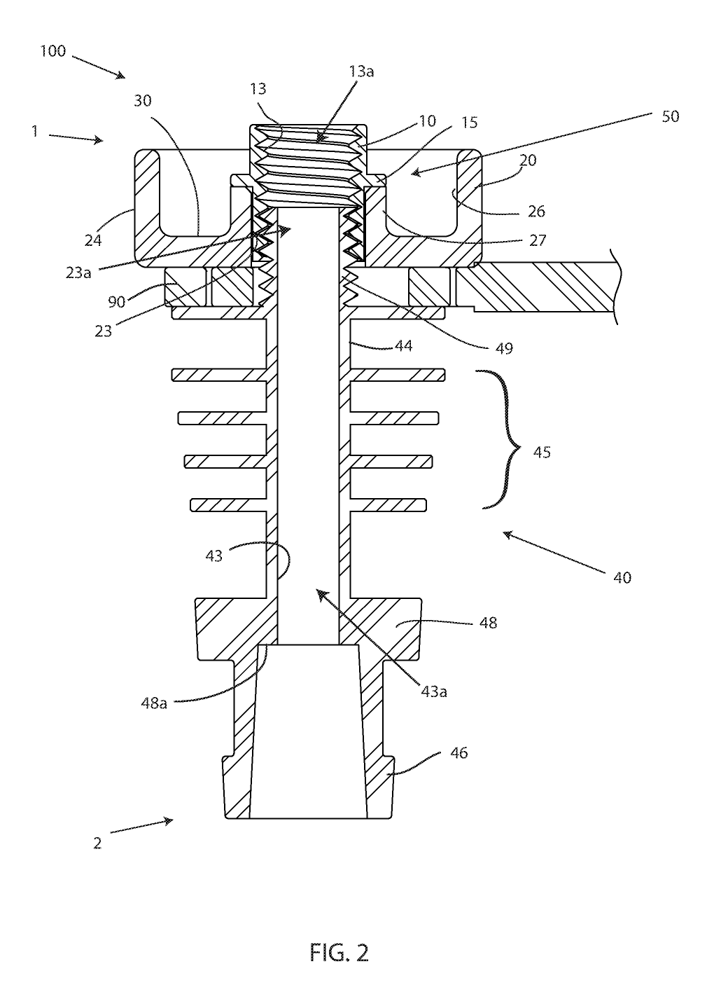

Referring to the drawings, FIGS. 1A-2 depicts an embodiment of a vaporizer 100. Embodiments of a vaporizer 100 may be also referred to as a nail, a portable nail, an electronic nail, a heatable element, a heat transfer element, or a heatable device for the vaporization and or heating of a medium 35. Embodiments of vaporizer 100 may vaporize a medium 35, such as an essential oil, oil, extract, herb, flavored nicotine, eliquids, ejuice, flavored oil(s), or other vaporizable medium. The medium 35 may be vaporized by heating the vaporizer 100, which can increase the temperature of the medium 35, as will be described in greater detail infra.

Embodiments of the vaporizer 100 may include a nail base 40 and a vaporizing component 50. In exemplary embodiment, the vaporizer 100 may be comprised of a vaporizing component 50 operably connected to the nail base 40. Embodiments of vaporizer 100 may include a medium collection device 20 having a vaporization contact surface 30, the medium collection device 20 configured to attach to a nail base 40, wherein the medium collection device 20 is comprised of Silicon Carbide (SiC). Further embodiments of vaporizer 100 may include a nail base 40 and a medium collection device 20 operably connected to the nail base 40, wherein the medium collection device 20 is comprised of SiC. Additional embodiments of vaporizer 100 may include a medium collection device 20 having a vaporization contact surface 30, the medium collection device 20 configured to attach to a nail base 40, wherein the medium collection device 20 is comprised of optical and/or semi conducting quartz. Further embodiments of vaporizer 100 may include a nail base 40 and a medium collection device 20 operably connected to the nail base 40, wherein the medium collection device 20 is comprised of optical and/or semi conducting quartz. In yet another embodiment, vaporizer 100 may include a medium collection device 20 having a vaporization contact surface 30, the medium collection device 20 configured to attach to a nail base 40, wherein the medium collection device 20 is comprised of synthetic sapphire. Further embodiments of vaporizer 100 may include a nail base 40 and a medium collection device 20 operably connected to the nail base 40, wherein the medium collection device 20 is comprised of synthetic sapphire. Embodiments may also utilize natural sapphire.

Embodiments of vaporizer 100 may include a nail base 40. Embodiments of the nail base 40 may be referred to as a main body, a nail body, a base, and the like. Embodiments of the nail base 40 may include a first end 41, a second end 42, an inner surface 43, and an outer surface 44. The nail base 40 may include a generally annular opening 43a therethrough extending between the first end 41 and the second 42. The generally annular opening 43a may be an opening, a channel, a bore, a gap, axial opening, and the like, or any pathway or passage that allows/guides the flow of fluid, such as vapor, gas, smoke, and the like. While a diameter of the central opening 43a of the nail base 40 may have a consistent diameter, some embodiments of the nail base 40 may include an internal lip 48a. The internal lip 48a may be a surface that extends in a radial direction away from a central axis of the axial opening 43a. Internal lip 48a may define an increase in the diameter of the inner opening 43a of the nail base 40 proximate an external flange 48 of the nail base 40. Starting from internal lip 48a, the diameter of the inner opening 43a of the nail base 40 may taper or continuously increase towards the second end 42 of the nail base 40. In other embodiments, nail base 40 may forego an internal lip, such as lip 48a, and taper or otherwise expand the diameter of the opening of the nail base 40 proximate, at, or otherwise near the second end 42 of the nail base 40.

Furthermore, embodiments of the nail base 40 may include a stem portion 49. Embodiments of the stem portion 49 may be cylindrical or substantially cylindrical, or may have various cross-sections. The stem portion 49 may be referred to as a stem or a base. The stem portion 49 may extend from the first end 41 to the external flange 48, or to the second 42 in the event an external flange 48 is not present. At least a portion of the stem portion 49, which may be a generally annular portion of the nail base 40 proximate the first end 41 of the nail base 40, may be configured to pass through and/or enter the central opening of the vaporization component 50 (which can include the medium collection device 20 and a coupler 10). Thus, a diameter of the stem portion 49 of the nail base 40, at least proximate the first end 41, may be sized and dimensioned to fit within the opening of the vaporization component 50 when in an assembled position. An outer surface of the stem portion 49 proximate a first end 41 may include threads for threadably engaging the coupler 10, as shown in FIG. 2.

Along the stem portion 49 of the nail base 40, a heat sink structure 45 may be positioned for thermal advantages, such as even and efficient heat dissipation of the nail base 40. Embodiments of the heat sink structure 45 may be comprised of a plurality of fins 45a that may have a high heat capacity. Embodiments of the fins 45a may be generally annular members that are structurally integral with the nail base 40 and protrude from an external surface 44 of the nail base 40. Other embodiments of a heat sink may be positioned on/along the stem portion 49 instead of a plurality of annular fins 45, including other cooling means. Additionally, embodiments of the nail base 40 may include an external lip 46 proximate the second end 42 of the nail base 40. The external lip 46 may define an increase in wall thickness proximate the second end 42 of the nail base 40. The second end 42 of the nail base 40 may be configured to be connected with a suction line or suction device. For instance, the second 42 may be sized and dimensioned to matingly correspond with an inlet, port, receiving means, or vaporizer holder of a suction device. Further, embodiments of the nail base 40 may be comprised of any thermally conductive material, including metal and metal alloys.

Referring still to FIGS. 1A-2, embodiments of the vaporizer 100 may include a vaporization component 50. Embodiments of the vaporization component 50 may include a medium collection device 20 and a retainer coupler 10. Embodiments of the medium collection device 20 may be operably connected to the retainer coupler 10 when being operably connected to the nail base 40. In alternative embodiments, the retainer coupler 10 may be operably connected after the medium collecting device 20 is operably connected to the nail base 40. In even further embodiments, the vaporization component 50 may only include the medium collective device 20; in other words, embodiments of vaporizer 100 may not need a retainer coupler 10 to achieve an assembled position. An embodiment of a fully assembled position is shown in FIG. 2, herein the vaporization component 50 is operably coupled to the nail base 40.

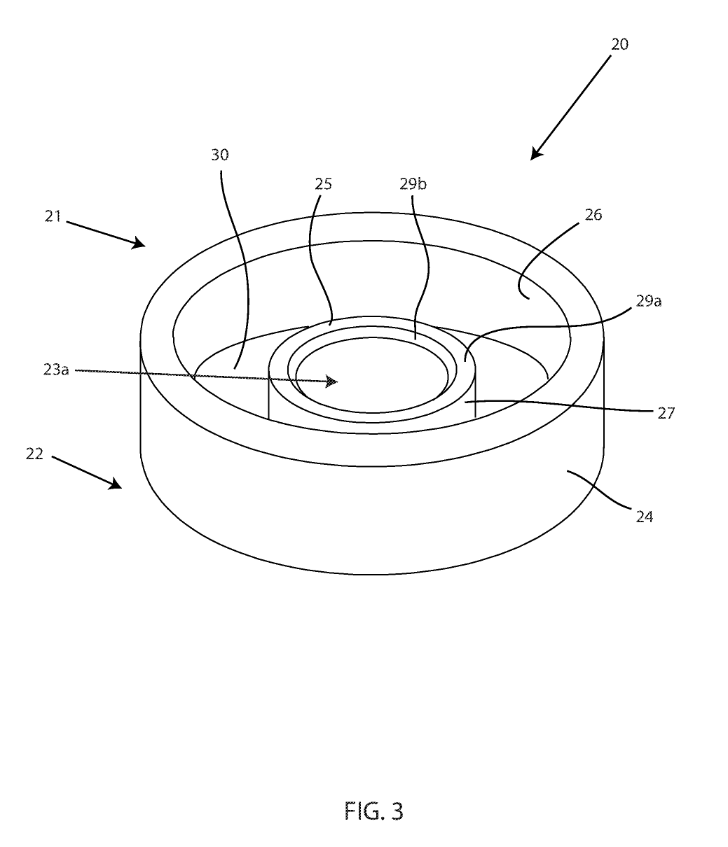

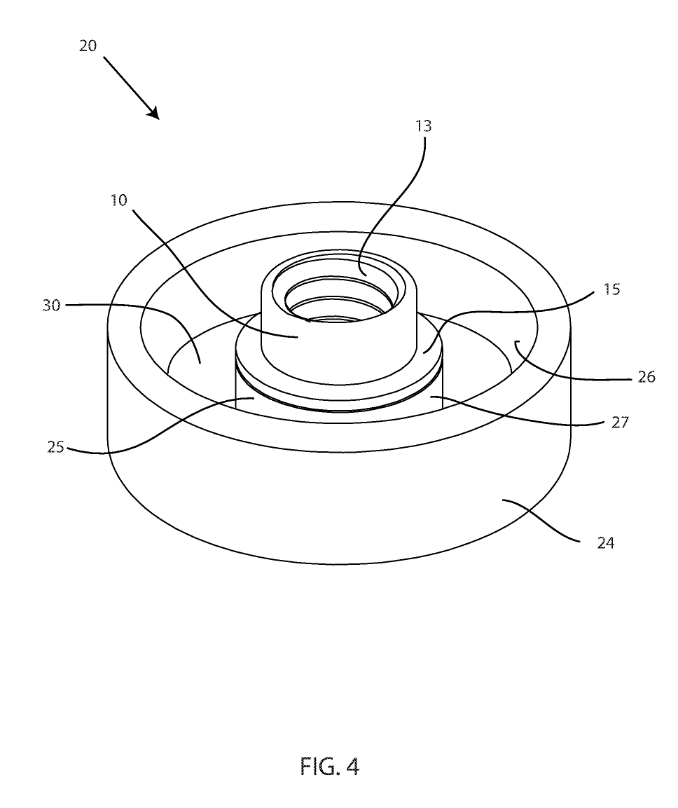

Referring additionally now to FIGS. 3 and 4, embodiments of the medium collection device 20 may be a dish, a dish component, a fluid collector, a bowl, a plate, a cup, a wafer, a cone, and the like, or any device that includes a surface, a channel, groove, bowl, or an opening for placing medium 35 to be vaporized. Embodiments of the medium collection device 20 may include a first end 21, a second 22, an inner surface 23, and an outer surface 24. For instance, medium collection device 20 may include a central opening 23a defined by an annular lip 25. The central opening 23a may be generally annular and axially extend along a central axis of the medium collection device 20. Embodiments of the opening 23a may be an entry point for vaporized medium to enter the general central, hollow opening 43a of the vaporizer 100 that may be configured to lead to a suction device, or a suction line. Moreover, embodiments of the medium collection device 20 may include a first wall 26 and a second wall 27. The first wall 26 may be an outer wall having a thickness defining an outer circumference or outer perimeter of the medium collection device 20. The second wall 27 may be an inner wall having a thickness defining the internal lip 25 within the medium collection device 20. In other words, the second wall 27 may be located closer to the center of the medium collection device 20 than the first wall 26. A height of the second wall 27 measured from a bottom surface 28 of the medium collection device 30 may be less than a height of the first wall 26 measured from the bottom surface 28.

Furthermore, the first wall 26 and the second wall 27 may be separated from each other by a distance. The surface of the medium collection device 30 that separates the first wall 26 and the second wall 27 may be a vaporization contact surface 30. For instance, the first wall 26 and the second wall 27 may be define a channel 34 therebetween for placing an amount of medium for vaporization, as shown in FIG. 1D. Embodiments of the channel between the walls 26, 27 may be a channel, a track, a ring, an opening, a gap, a void, and the like, being defined by a floor or surface 30 and the walls 26, 27. Embodiments of the surface 30 may be a contact point for vaporization, wherein the contact point for vaporization may be comprised of the material used for the medium collection device 20, or a coating on the surface 30. When the medium 35 is placed within the medium collection device 20 along at least a portion of the vaporization surface 30, heat may be applied/transferred via a heating element, such as heating element 90, to the medium collection device 20 of the vaporizer 100. The applied/transferred heat vaporizes the medium 35, the vapor then being drawn through the central opening 23a of the medium collection device 20 and the central opening 43a of the vaporizer 100 through a negative air pressure from a suction device or line operably attached to the second end 2 of the vaporizer 100. When the vaporizer 100 is in an assembled position, as shown in FIG. 2, the inner opening 43a of the nail base 40 may be aligned with an inner opening 23a, 13a of the vaporizing component 50 to form the central opening (fluid pathway) of the vaporizer 100. Thus, vaporized medium 35 may flow through the openings from a first end 1 of the vaporizer 100 to a second end 2 of the vaporizer to an inlet of a suction device (not shown) by the use of the suction device.

Embodiments of the medium collection device 20 may be comprised of silicon carbide. Silicon carbide is very chemically resistant, and may be unaffected by extracts and other medium, such as medium 35, vaporized through use of vaporizer 100. Silicon carbide also has a high thermal conductivity that may easily facilitate a transfer of heat from the heating element 90 to the medium 35. In addition, silicon carbide has a low coefficient of surface adhesion that can allow the medium collection device 20 to be cleaned. Because the medium collection device 20 may be comprised of silicon carbide, a vaporization contact point, such as surface 30 is improved for vaporization of medium 35. In alternative embodiments, portions of the medium collection device 20 may be made of other material(s) than silicon carbide, wherein the surface 30 that directly engages or touches the medium 35 is comprised of silicon carbide. In further embodiments, surface 30 may be coated with a layer of silicon carbide to take advantage of the thermal and chemical properties of silicon carbide, while reducing the poor machinability of the material.

Embodiments of the medium collection device 20 being made from all or a portion of silicon carbide may be utilized with many different configurations of nail bases, including nail base 40. For instance, the embodiments of nail base 40 may not limited to the particular structural configuration disclosed herein, and the medium collection device 20 may still operate with its advantages on other structural configurations of a vaporizer having a nail base or other base structure.

Moreover, embodiments of the medium collection device 20 may be comprised of optical or semi conducting quartz. Optical or semi conducting quartz is very chemically resistant, and may be unaffected by extracts and other medium, such as medium 35, vaporized through use of vaporizer 100. In addition, optical or semi conducting quartz has a low coefficient of surface adhesion that can allow the medium collection device 20 to be cleaned. Because the medium collection device 20 may be comprised of optical or semi conducting quartz, a vaporization contact point, such as surface 30 is improved for vaporization of medium 35. In alternative embodiments, portions of the medium collection device 100 may be made of other material(s) than optical or semi conducting quartz, wherein the surface 30 that directly engages or touches the medium 35 is comprised of optical or semi conducting quartz. In further embodiments, surface 30 may be coated with a layer of optical or semi conducting quartz to take advantage of the properties of optical or semi conducting quartz, while reducing the poor machinability of the material.

Embodiments of the medium collection device 20 being made from all or a portion of optical or semi conducting quartz may be utilized with many different configurations of nail bases, including nail base 40. For instance, the embodiments of nail base 40 may not limited to the particular structural configuration disclosed herein, and the medium collection device 20 may still operate with its advantages on other structural configurations of a vaporizer having a nail base or other base structure.

Alternatively, embodiments of the medium collection device 20 may be comprised of synthetic sapphire. Synthetic sapphire is very chemically resistant, and may be unaffected by extracts and other medium, such as medium 35, vaporized through use of vaporizer 100. In addition, synthetic sapphire has a low coefficient of surface adhesion that can allow the medium collection device 20 to be cleaned. Because the medium collection device 20 may be comprised of synthetic sapphire, a vaporization contact point, such as surface 30 is improved for vaporization of medium 35. In alternative embodiments, portions of the medium collection device 100 may be made of other material(s) than synthetic sapphire, wherein the surface 30 that directly engages or touches the medium 35 is comprised of synthetic sapphire. In further embodiments, surface 30 may be coated with a layer of synthetic sapphire to take advantage of the properties of synthetic sapphire, while reducing the poor machinability of the material.

Embodiments of the medium collection device 20 being made from all or a portion of synthetic sapphire may be utilized with many different configurations of nail bases, including nail base 40. For instance, the embodiments of nail base 40 may not limited to the particular structural configuration disclosed herein, and the medium collection device 20 may still operate with its advantages on other structural configurations of a vaporizer having a nail base or other base structure.

Referring back to FIGS. 1A-2, embodiments of the vaporization component 50 may include a retainer coupler 10. The coupler 10 may be a retainer, a retainer coupler, a coupler, a lug, a nut, a connector, and the like. Embodiments of the coupler 10 may be a generally annular or annular member, and may have a first end 11, a second end 12, an inner surface 13, an outer surface 14, and a generally axial opening 13a therethrough. The inner surface 13 may include threads for threadably engaging outer threads proximate the first end 41 of the nail base 40 on stem portion 49, as shown in FIG. 2. Moreover, embodiments of coupler 10 may include a flange 15, wherein flange 15 may protrude radially outward from the outer surface 14. An underside of the flange 15 may be configured to engage surface 29a of the medium collection device 20 when in an assembled position. For instance, a portion of the coupler 10 starting from the flange 15 and extending towards the second end 12 of the coupler may be received within the central axial opening 23a of the medium collection device 20 when in an assembled position.

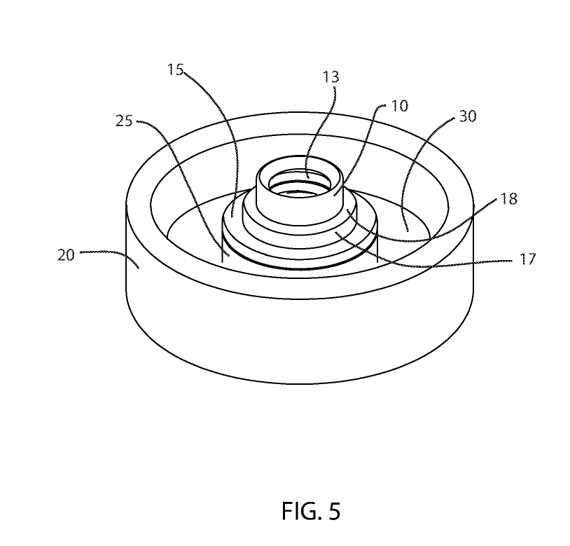

FIG. 5 depicts an alternative embodiment of a coupler 10, wherein a coupler 10 may include an additional flange 17. The additional flange 17 may also be referred to as a lip, shelf, annular lip, and the like. The additional flange 17 may protrude radially outward from the outer surface 14 of the coupler 10, and may be disposed directly above the flange 15. In some embodiments, there may be a gap between the flange 15 and the additional flange 17. The additional flange 17 may include a surface 18, which may act as a shelf for an additional medium collection device, such as device 20, or a dish component made of any material. Accordingly, the vaporizer 100 may have multiple dishes; the thickness of the additional flange 17 (and potentially a gap between the flange 15 and the additional flange 17) may define a distance between the two dishes.

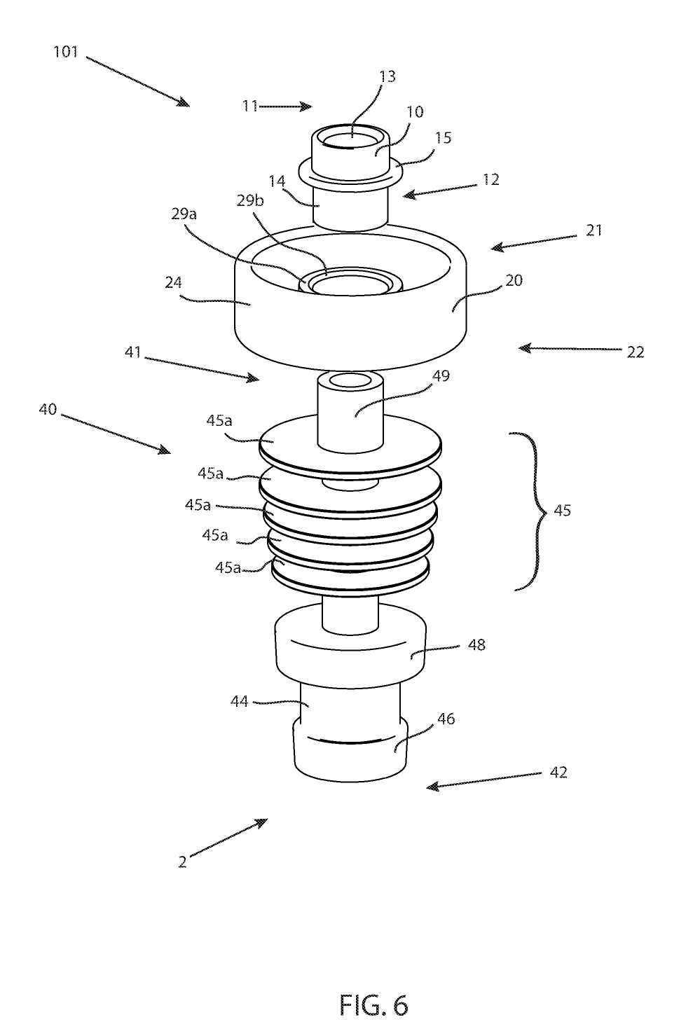

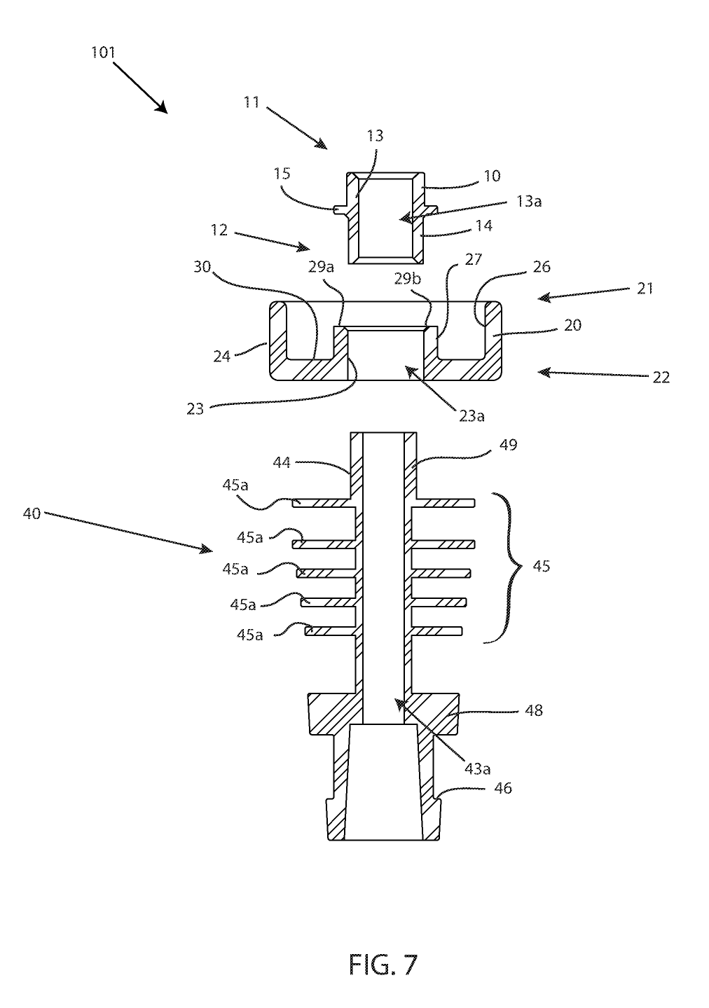

Further embodiments of vaporizer 100 may include a heating element 90. Embodiments of the heating element 90 may be configured to apply/transfer heat to the nail base 40 and the vaporization component 50. Embodiments of the heating element 90 may include a heater arm 95 and a heating coil 93. The heating coil 93 may be disposed between the nail base 40 and the vaporization component 50 for operation of the vaporizer 100. For example, a fin 45a of the plurality of fins 45a closest to the first end 41 of the nail base 40 may act as a shelf for the heating element 90. The heating coil 93 may include an opening sized and dimensioned to receive the first end 41 of the nail base 40 in the assembled position. The heating coil 93 may physically mechanically engage with the nail base 40 and/or the vaporization component 50 so that the components are in thermal communication. As shown in FIGS. 6 and 7, embodiments of the vaporizer 100 may be packaged and sold without a heating element 90; the heating element 90 may be disposed between the nail base 40 and the vaporization component 50 during assembly.

Components of the vaporizer 100 may be assembled and reassembled before and after use. For example, a user may operably connect the vaporization component 50 to the nail base 40, and then remove the vaporization component 50 for cleaning and/or storage, all without damaging the vaporizer 100. Operably connection of the vaporization component 50 to the nail base 40 may be a threaded connection between one or more components. Due to the poor machinability of SiC, optical or semi conducting quartz, and/or synthetic sapphire, embodiments of the vaporizer 100 may include a means for threadably attached the medium collection device 20 to the nail base 40 without a need to provide threads on the medium collection device 20. For example, an inner surface 13 of the retainer coupler 10 may include a threaded surface, while an outer surface of the stem portion 49 proximate the first end 41 of the nail base 40 includes a threaded surface that threadably matingly corresponds to the threaded surface of the retainer coupler 10. The retainer coupler 10 may be disposed within a central opening 23a of the medium collection device 20, wherein a flange 15 of the retainer coupler 10 engages surface 29a and potentially chamfer 29b of the medium collection device 20, and the threaded surfaces of the retainer coupler 10 and stem portion 49 threadably engage to releasably secure, attach, or otherwise connect the vaporization component 50 to the nail base 40. In other words, the coupler 10 may threadably releasably secure the medium collection device 20 into position with the nail base 40. Prior to connection of the retainer coupler 10 and stem portion 49 of nail base 40, the heating element 90 may be disposed around the nail base 40 onto one of the fins 45a of the plurality of fins 45. Alternative embodiments may include operably connecting the vaporization component using press fit machined components, axial compression, tongue and groove, ball and detent, and other comparable mechanical fastening techniques.

FIGS. 6-7 depict an embodiment of vaporizer 101. Embodiments of vaporizer 101 may share the same or substantially the same structural and/or functional aspects of vaporizer 100 as described above. However, embodiments of vaporizer 101 may be assembled without a heating element, such as heating element 90. A heating element may be utilized with embodiments of vaporizer 101.

Referring now to FIGS. 1-7, a method may include the steps of forming a medium collection device 100 at least partially (or wholly) of silicon carbide, optical or semi conducting quartz, or synthetic sapphire to improve a vaporization contact surface, such as surface 30. Further a method may include operably coupling the medium collection device 20 to the nail base 40 by using a retainer coupler 10, so that the medium collection device 20 may not require threads, but also be securably attached to the nail base 40.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. An apparatus comprising:
a medium collection device having a vaporization contact surface, the medium collection device configured to attach to a nail base;
wherein the medium collection device is comprised at least partially of silicon carbide (SiC), optical or semi conducting quartz, or synthetic sapphire.

2. The apparatus of claim 1, wherein the vaporization contact surface is a surface of the medium collection device defined by a first wall and a second wall having a channel therebetween.

3. The apparatus of claim 1, wherein the nail base includes a heat sink structure, the heat sink structure having a plurality of fins extending radially from a stem portion of the nail base.

4. The apparatus of claim 1, further comprising a coupler for securing the medium collection device to the nail base, wherein a flange of the coupler engages a surface of the medium collection device when in a fully assembled position.

5. The apparatus of claim 4, wherein the coupler includes an inner threaded surface for threadably engaging an outer threaded surface of the nail base.

6. The apparatus of claim 1, wherein the coupler includes an additional flange having a surface that acts as a shelf for an additional medium collection device.

7. The apparatus of claim 1, further comprising a heating element configured to be disposed between a portion of the nail base and the medium collection device for the application of heat to vaporize a medium disposed within the medium collection device.

8. The apparatus of claim 1, wherein an end of the nail base is configured to be attached to a suction device for drawing in vapor from a medium that is vaporized within the medium collection device.

9. The apparatus of claim 1, wherein the medium is at least one of an essential oil, oil, extract, herb, flavored nicotine, eliquid, ejuice, and flavored oil.

10. A vaporizer comprising:
a nail base; and
a vaporization component operably connected to the nail base, the vaporization component including a medium collection device and a coupler;
wherein the coupler secures the medium collection device to the nail base by threaded engagement between the coupler and the nail base.

11. The vaporizer of claim 10, wherein the medium collection device is comprised of SiC.

12. The vaporizer of claim 10, wherein the medium collection device is comprised of optical or semi conducting quartz.

13. The vaporizer of claim 10, wherein the medium collection device is comprised of synthetic sapphire.

14. The vaporizer of claim 10, wherein the nail base includes a heat sink structure, the heat sink structure having a plurality of fins extending radially from a stem portion of the nail base.

15. The apparatus of claim 10, wherein a flange of the coupler engages a surface of the medium collection device when in a fully assembled position.

16. The apparatus of claim 15, wherein the coupler includes an additional flange having a surface that acts as a shelf for an additional medium collection device.

17. The vaporizer of claim 10, further comprising a heating element configured to be disposed between a portion of the nail base and the medium collection device for the application of heat to the vaporizer.

18. The apparatus of claim 10, wherein the coupler includes an inner threaded surface for threadably engaging an outer threaded surface of the nail base.

19. The apparatus of claim 10, wherein an end of the nail base is configured to be attached to a suction device for drawing in vapor from a medium that is vaporized within the medium collection device.

20. A method comprising:
forming a medium collection device at least partially of silicon carbide, optical or semi conducting quartz, or synthetic sapphire to improve a vaporization contact surface; and
operably coupling the medium collection device to a nail base by using a coupler, so that the medium collection device may not require threads, but also be securably attached to the nail base.
